(19) United States
(12) Patent Application Publication
(10) Pub. No.: US 2026/0093614 A1
(43) Pub. Date: Apr. 2, 2026

(54) GRAPHICAL USER INTERFACE FOR PROMPT TESTING AND EVALUATION

(71) Applicant: Navan, Inc., Palo Alto, CA (US)

(72) Inventors: Ilan Ezra Twig, San Francisco, CA (US); Chen Zhang, Santa Clara, CA (US); Ishay Shushu Inbar, Neot HaKikar (IL); Andrei Vodeniktov, Sunnyvale, CA (US)

(21) Appl. No.: 19/346,006

(22) Filed: Sep. 30, 2025

Related U.S. Application Data
(60) Provisional application No. 63/824,752, filed on Jun. 16, 2025.
(60) Provisional application No. 63/703,731, filed on Oct. 4, 2024.
(60) Provisional application No. 63/702,053, filed on Oct. 1, 2024.

(51) Int. Cl. G06F 11/3698; G06F 11/3668

(52) U.S. Cl. CPC G06F 11/3698; G06F 11/3688

(57) ABSTRACT

An online system improves the development and deployment of LLM-based applications providing offering a prompt testing user interface to developers of these applications. The prompt testing user interface includes a control subsection and a test subsection, where each subsection comprises a prompt element and an output element. The prompt element is a user interface element that displays the text of a prompt used for the corresponding subsection, and the output element is a user interface element that displays output from a large language model when the model is applied to the prompt of the corresponding subsection. The online system generates outputs for prompts of each subsection by applying the large language model to the prompt. The online system updates the output element of the corresponding subsection in the prompt testing interface to display the outputs.

### BACKGROUND

This application claims the benefit of U.S. Provisional Application No. 63/702,053, filed October 1, 2024, U.S. Provisional Application No. 63/703,731, filed October 4, 2024, and U.S. Provisional Application No. 63/824,752, filed June 16, 2025, each of which are incorporated by reference in their entirety.

### BACKGROUND

Large language models (LLMs, also referred to as generative language models herein), such as OpenAI’s GPT models, are machine-learning models that are trained to predict text that should follow input prompt text provided by a user. Because human knowledge is commonly articulated through text, LLMs can be used to respond to user questions by predicting the text that would respond to the user. However, LLMs suffer from a number of problems with their consistency and accuracy. For example, LLM may suffer from the “hallucination problem,” which is where the LLM outputs text that appears to correctly respond to the user’s question but is actually incorrect. Similarly, LLMs can suffer from inconsistency in responses or from problems with “attention,” where an LLM’s attention mechanism fails to appropriately weight the relevance of pieces of context to the output. These problems can be acute when the user’s question requires significant logical analysis by the LLM. Conversely, the hallucination problem is less significant when the LLM is asked to make a simple logical step or asked to provide an answer with minimal amounts of “judgment” needed to produce the output. However, LLMs are significantly limited in their capabilities if constrained to responding to simple questions from users.

One common approach is to expand the size of LLMs to improve their performance. For example, LLM developers may add more parameters to a multilayer perceptron or the attention mechanism to improve the performance of the LLM. However, bigger LLMs require significantly more resources to operate, and some research has indicated that bigger LLMs tend to be more likely to give wrong answers than admit ignorance.

Some systems address this problem by providing comprehensive instructions in the prompt to the LLM. For example, the prompt may include contextual information needed to make decisions, instructions on how the output should be structured or how to test the output, and examples of correct and incorrect outputs. However, there can be two problems with this approach. First, LLMs have context windows of limited size, so, if more tokens are used to provide instructions to the LLM, then fewer tokens can be used to inform the LLM with the data needed to make a decision. Second, as noted above, the attention mechanisms that LLMs use can fail to generate the intended output when the LLM prompts get large. Specifically, it can be difficult for LLM attention mechanisms to account for all of the different instructions that are included in large prompts, which typically leads to LLMs overly focusing on certain portions of the instructions and ignoring others.

Furthermore, when a user request is transactional rather than informational, using a single, long prompt may cause the LLM to hallucinate or invent parameters or results, such as suggesting actions that are not actually being performed. For example, the LLM may suggest to a user that it is searching for flights to San Francisco, where the “San Francisco” destination could be hallucinated. Furthermore, the action of search may only be reported to the user but never actually performed. This can lead to incorrect assumptions about what is happening with the user's request.

### SUMMARY

An online system improves the development and deployment of LLM-based applications using an agentic workflow for prompting, parallelizing application programming interface (API) calls in an agentic workflow, offering an application workflow user interface (“UI”) to developers of these applications, and using a supervisor routine to analyze LLM outputs before presentation to users. These concepts may be applied together or separately in the online system to improve the accuracy of outputs of LLMs.

An agentic workflow is a workflow that uses generative machine-learning models (e.g., generative language models like Large Language Models) to perform tasks based on a user’s input. These agentic workflows include a plurality of nodes that represent computing stages in a workflow, and the nodes are connected in the agentic workflow such that the online system can traverse the workflow to perform an intended action for a user. By using the agentic workflow, the online system may apply one or more LLMs to determine a response to a query, with less risk of hallucinating or otherwise generating a response that does not address the query, and assist engineers with deploying agentic solutions.

An agentic workflow may include different types of nodes, such as prompt nodes or agentic nodes. Prompt nodes are nodes in the workflow for prompting an LLM based on a prompt template. The online system may generate a prompt based on the prompt template and apply an LLM to the generated prompt to generate an output. Agentic nodes are nodes that interface with a system (e.g., a subsystem within the online system or a third-party system) to perform some action. For example, agentic nodes may include computer-executable instructions for querying a database for data for processing by the online system. The agentic workflow may further include dispatch nodes to determine command categories related to user responses to the system. The online system may use the command categories to determine a next node in the agentic workflow to execute.

The online system may execute some of the nodes in an agentic workflow in parallel, thus reducing processing time required to generate a response to a user’s question. For example, the online system may access an agentic workflow and execute instructions for a node in the agentic workflow. While the online system is executing the instructions of the node, the online system may identify a set of nodes that descend from the node in the agentic workflow. The online system determines, for each node in the set, whether preconditions of the node have been met. In response to the preconditions of a node being met, the online system executes the instructions associated with that node.

The online system also may use supervisor nodes to determine the efficacy of an LLM-determined response to an input query before providing the response to a user (e.g., via a chat interface). The online system may receive an output from a prompt node in an agentic workflow. A supervisor node generates a prompt with a request for a set of error scores, where each error score corresponds to a type of error that may be included in the output. The online system inputs the prompt to an LLM, which generates the set of error scores. The online system determines if the output includes any of the types of errors based on the set of scores, and, in response to detecting one or more types of errors, may cause the node that provided the output to generate a new output.

An application workflow UI is a user interface that includes different sections for the efficient design of a workflow and logic for an application operating on the online system. The application workflow UI allows the user to test portions of the overall application workflow. The application workflow UI improves the development process of LLM-based applications, such as chatbot applications, by allowing the user to set parameters for portions of the overall application workflow that involve prompting an LLM through the same interface. Specifically, the application workflow UI includes a control subsection and a test subsection, where the control subsection includes a control prompt and a control output and the test subsection includes a test prompt and a test output. The application workflow UI may be configured to receive interactions such that a user can alter the test prompt to receive a new test output. The test output is displayed on the application workflow UI in the test subsection such that the test output may be visually compared to the control output in the control subsection.

Though the description below primarily focuses on an online system providing a chat interface to a user and determining a user’s intent in the chat, the principles described can be applied more broadly to minimize the likelihood of hallucination by a large language model in answering questions from users.

### BRIEF DESCRIPTION OF THE DRAWINGS

FIG. 1 illustrates an example system environment for an online system, in accordance with some embodiments.

FIG. 2 illustrates an example agentic workflow, in accordance with some embodiments.

FIG. 3 is a flowchart of a method for processing nodes of an agentic workflow, in accordance with one or more embodiments.

FIG. 4 illustrates an example structure of a prompt testing user interface, in accordance with some embodiments.

FIG. 5 is a flowchart of a method presenting and updating a prompt testing user interface, in accordance with some embodiments.

FIG. 6 illustrates an example prompt testing user interface, in accordance with one or more embodiments.

FIG. 7 is a flowchart of a method for executing candidate nodes in parallel with execution of a current node, in accordance with one or more embodiments.

FIGS. 8A-B illustrate portions of an agentic workflow including agentic nodes, in accordance with some embodiments.

FIGS. 9A-B illustrate example applications of a supervisor routine, in accordance with some embodiments.

FIGS. 10A-B illustrate a flowchart of a method for applying a supervisor routine to an output of a generative language model, in accordance with one or more embodiments.

### DETAILED DESCRIPTION

### System Environment

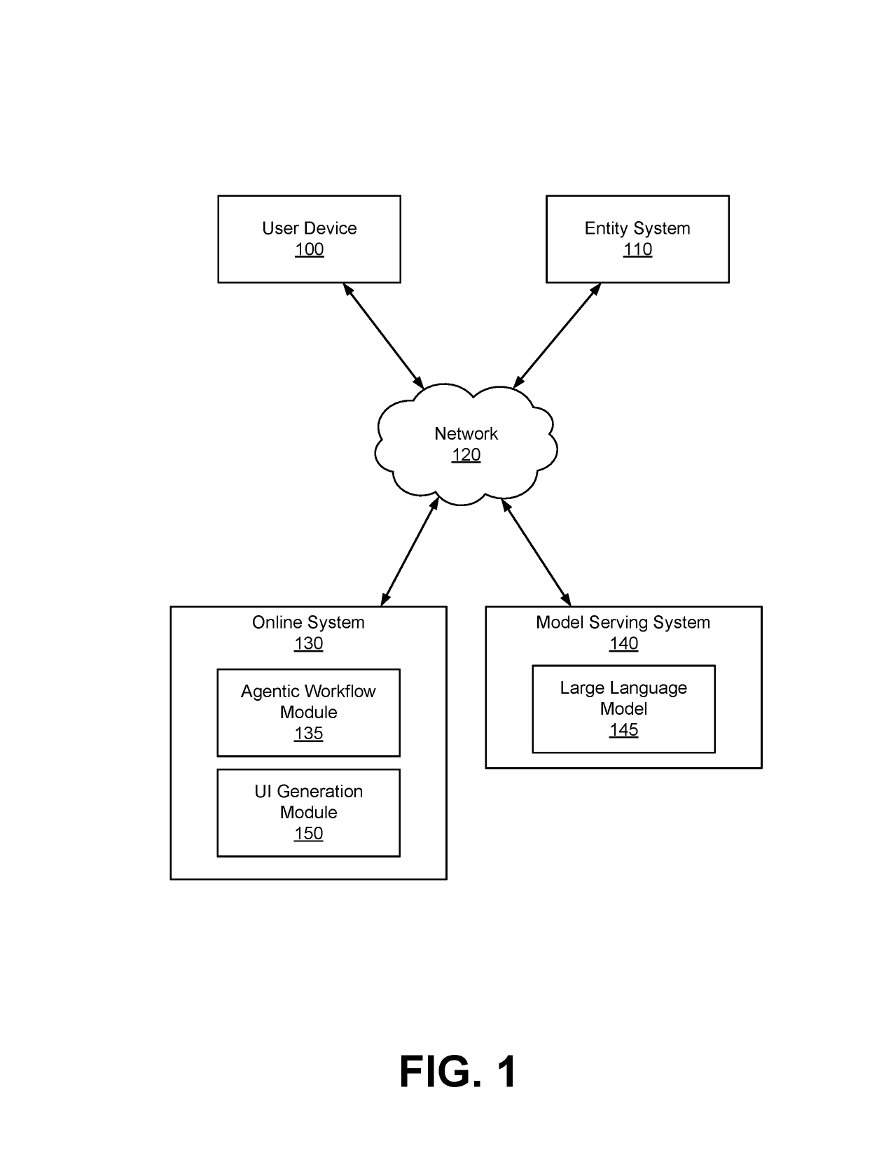

FIG. 1 illustrates an example system environment for an online system 130, in accordance with some embodiments. The system environment illustrated in FIG. 1 includes a user device 100, an entity system 110, a network 120, an online system 130, and a model serving system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

A user can interact with other systems through a user device 100. The user device 100 can be a personal or mobile computing device, such as a smartphone, a tablet, a laptop computer, or desktop computer. In some embodiments, the user device 100 executes a client application that uses an application programming interface (API) to communicate with other systems through the network 120.

The entity system 110 is a computing system operated by an entity. The entity may be a business, organization, or government, and the user may be an agent or employee of the entity. The entity system 110 may interface with the online system 130 to execute agentic workflows on behalf of the entity. For example, users associated with the entity may use the online system to develop and deploy agentic workflows.

The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include Bluetooth or near-field communication (NFC) technologies or protocols for local communications between computing devices. Similarly, the network 120 may use phone lines for communications. The network 120 may transmit encrypted or unencrypted data.

The online system 130 generates, stores, and executes agentic workflows. The online system may implement its own agentic workflows or may enable users to generate their own agentic workflows for execution on the online system. The functionality of the online system is described in further detail below.

The model serving system 140 receives requests from other systems to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 140 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 140 receives a request including input data (e.g., text data, audio data, image data, or video data) and encodes the input data into a set of input tokens. The model serving system 140 may apply a machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens may be arranged as a tensor with one or more dimensions, for example, one dimension, two dimensions, or three dimensions. In an example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, a large language model (LLM) 145 (also referred to as a generative language model herein) of the model serving system 140 is trained on a large corpus of training data to generate outputs for the NLP tasks. Though only one LLM 145 is shown in FIG. 1, the online system 130 may include or interact with any number of LLMs 145. The LLM may be trained on massive amounts of text data, often involving billions of words or text units. The large amount of training data from various data sources allows the LLM 145 to generate outputs for many tasks. The LLM 145 may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since the LLM 145 may have significant parameter size and the amount of computational power for inference or training the LLM 145 is high, the LLM 145 may be deployed on an infrastructure configured with, for example, supercomputers that provide enhanced computing capability (e.g., graphic processor units) for training or deploying deep neural network models. In one instance, the LLM 145 may be trained and deployed or hosted on a cloud infrastructure service. The LLM 145 may be pre-trained by the online system 130 or one or more entities different from the online system 130. An LLM 145 may be trained on a large amount of data from various data sources. For example, the data sources include websites, articles, posts on the web, and the like. From this massive amount of data coupled with the computing power of LLMs, the LLM 145 is able to perform various tasks and synthesize and formulate output responses based on information extracted from the training data.

In one embodiment, when the machine-learned model including the LLM 145 is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While an LLM 145 with a transformer-based architecture is described as a primary embodiment, it is appreciated that in other embodiments, the LLM 145 can be configured as any other appropriate architecture including, but not limited to, long short-term memory (LSTM) networks, Markov networks, BART, generative-adversarial networks (GAN), diffusion models (e.g., Diffusion-LM), and the like. The term “LLM” or “large language model” may be used herein to describe any generative machine-learning language model that generates a text output based on a text input prompt. Similarly, unless otherwise specified, other kinds of generative machine-learning models (e.g., image-, audio-, or video-generating models) may be used herein where appropriate.

While the model serving system 140 is depicted as separate from the online system 130 in FIG. 1, in alternative embodiments, the model serving system 140 is a component of the online system 130.

Though the system can be applied in many environments, in one example, the online system 130 is an expense management system. An expense management system is a computing system that manages expenses incurred for an entity by users. An example system is described in further detail in U.S. Patent Application No. 18/487,821 filed October 16, 2023, which is incorporated by reference.

In FIG. 1, the online system 130 includes an agentic workflow module 135 and a user interface (UI) generation module 150. Alternative embodiments may include more, fewer, or different components from those illustrated in FIG. 1, and the functionality of each component may be divided between the components differently from the description below. Additionally, while the description below primarily describes the functionality of the modules as being performed by the online system, some or all of the functionality of the online system may be performed by other systems, such as the user device 100, the entity system 110, or the model serving system 140.

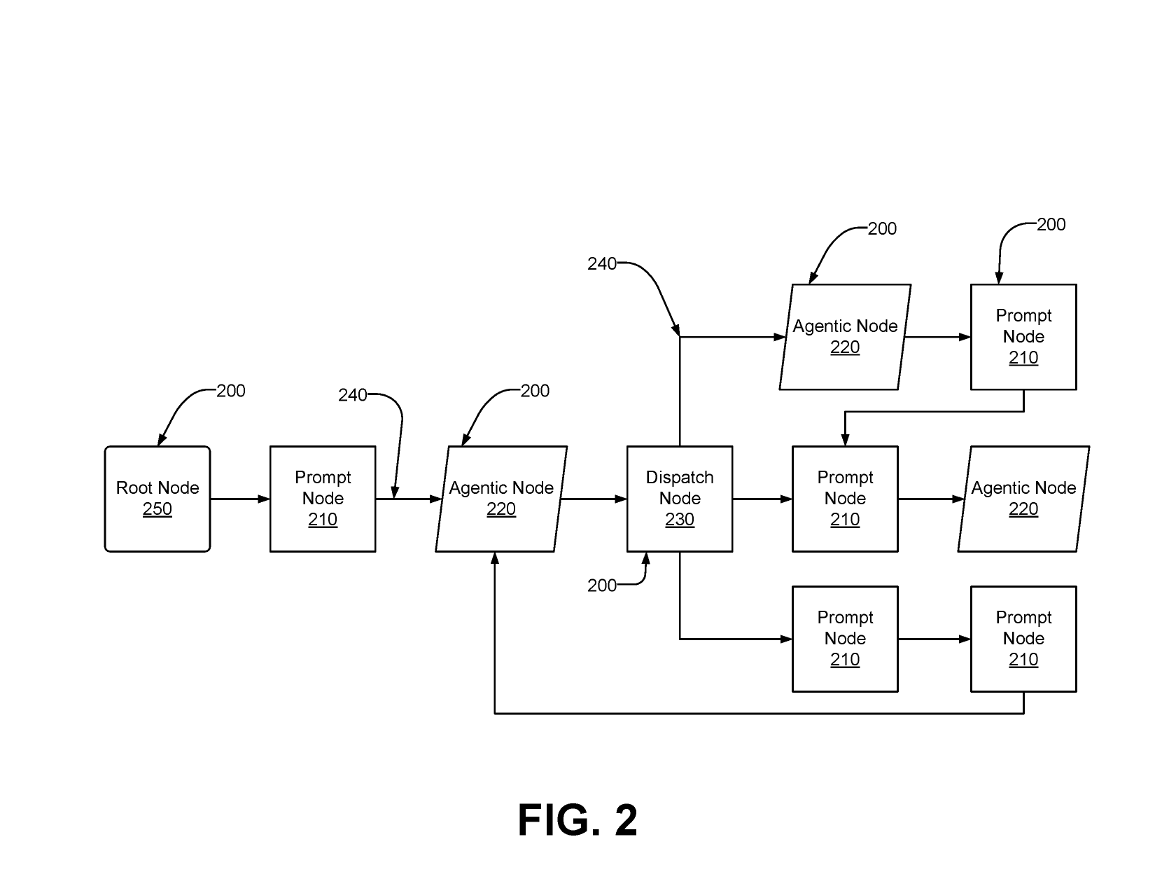

The agentic workflow module 135 generates, stores, and executes agentic workflows. FIG. 2 illustrates an example agentic workflow, in accordance with some embodiments. An agentic workflow is a data structure that represents the steps to be taken by an agentic subsystem or process of the online system. An agentic subsystem or process is one that leverages generative machine-learning models (e.g., an LLM) to perform operations. For example, an agentic subsystem may be a chatbot system that provides support for users of the online system, uses a generative language model to interpret a user’s input to determine an action to take, and interacts with relevant subsystems or third-party systems to perform the action. An agentic workflow for such an agentic subsystem may define how the agentic system asks the user questions or which other systems the agentic system interfaces with.

An agentic workflow includes a set of nodes 200. The nodes represent actions or sets of actions taken by the online system at that step in the workflow and the edges indicate where an output from one node should be used for another node. In general, each node has a set of computing steps to be executed by the online system 130 when that node is “executed.” For example, a node’s computing steps may be computer-executable instructions, such as general-purpose source code or domain-specific language code (e.g., SQL or a domain-specific language that is used by the online system for agentic workflows). In some embodiments, a node’s computing steps include text, images, or video for prompts to a generative machine-learning model, as well as other computer-executable instructions for inputting prompts to the model.

In some embodiments, a node’s computer-executable instructions include primary instructions, input instructions, and output instructions. The primary instructions are instructions that correspond to the main functionality of the node. For example, the primary instructions may be code for querying data from a database or may be a template for a prompt to a generative ML model. The input instructions are instructions for preprocessing data for the primary instructions. For example, the input instructions of a node may cause the online system 130 to extract fields from a JSON received at the node from another node. Similarly, the output instructions are instructions for post-process data generated by the primary instructions. For example, the output instructions of a node may cause the online system 130 to generate a JSON based on the output of the primary instructions. The output instructions may also include instructions to which other node the output of the node should be transmitted to.

The online system 130 may access global data during executing of computer-executable instructions of nodes. The global data may include user data associated with a user of the online system 130 entity data associated with an entity of the online system 130 and may be accessible without the online system 130 interfacing with external systems. For example, the global data may be a global variable that is accessible within functions of the online system 130. In some embodiments, execution of instructions at the nodes may cause modification of globally accessible data. For example, storage or modification of globally accessible data may occur based on execution of instructions from agentic nodes.

The nodes in the workflow may have different types based on what action is performed by the node. For example, a node’s type may specify what kind of instructions (e.g., primary instructions, input instructions, or output instructions) are included in the respective node.

Generally, agentic workflows include prompt nodes 210 and agentic nodes 220 as node types. Prompt nodes are nodes for prompt an LLM 145 to generate an output for the agentic workflow. Agentic nodes are nodes for interfacing (e.g., with an API call) with a subsystem of the online system 130 or with a third-party system.

Prompt nodes include prompt templates for prompting an LLM 145 to generate an output. This prompt template may be included in the primary instructions of a prompt node. For example, the primary instructions may include free text to be used in the prompt. In some embodiments, the primary instructions may cause the online system 130 to extract/generate field values for fields in the prompt template based on data input to the prompt node, and the online system 130 generates the prompt by filling in the prompt template with the extracted fields. In some embodiments the primary instructions for the prompt node include parameters for prompting the LLM 145, such as which LLM 145 of a plurality of LLMs to prompt or a temperature for the output of the LLM 145.

Agentic nodes are nodes for interfacing with subsystems of the online system or with third-party systems. For example, agentic nodes generally include computer-executable instructions (e.g., source code) for performing interfacing actions based on input data, such as responses to prompts output by prompt nodes. The agentic nodes may include API nodes, which use an application programming interface (API) to interface with other systems. For example, the computer-executable instructions for an API agentic node may cause the online system 130 to execute an API call to a third-party system or a subsystem of the online system 130 to access data stored by those systems or to perform some action using those systems. Other examples of agentic nodes include database access nodes, which include computer-executable instructions for extracting data stored at the online system 130 or with a third-party system for other nodes (e.g., prompt nodes or API nodes), or functionality nodes, which include computer-executable instructions for executing some other process or system within the online system 130 to perform some functionality as part of the associated stage (e.g., applying a stored machine-learning model to certain data or performing certain confidentiality or privacy checks on data).

In some embodiments, the agentic workflow includes dispatch nodes 230, which are prompt nodes that identify branches within the agentic workflow for addressing user queries received by the online system 130. Each dispatch node includes computer-executable instructions for prompting the LLM 145 to categorize an intent of a user interacting with the online system. For instance, the dispatch node may include a dispatch prompt template in its primary instructions. A dispatch prompt template is a prompt template with instructions of identifying an intent (e.g., “command”) of a user based on natural-language text received from a user device 100. A dispatch prompt may include descriptions of commands and instructions to select a command category for the described command from a set of command categories. The command categories represent different descriptions of the intent of a user determined based on natural-language text received from a user device 100. Each command category includes an edge that connects to another node in the agentic workflow. In some embodiments, the agentic workflow has a set of sub-workflows for performing different actions. The sub-workflows may be grouped such that a dispatch node selects a sub-workflow among each group of workflows. Thus, each dispatch node may be the beginning of a sub-workflow with computer-executable instructions that cause the online system 130 to perform a corresponding command.

In some embodiments, a dispatch prompt includes instructions describing factors for the LLM 145 to consider during application of the LLM 145 to the dispatch prompt. Examples of factors include schema of a query or output, semantic context of a query, data types related to the query, and permissions associated with a user that provided the query. In some embodiments, the dispatch prompt includes a reprompt flag that the LLM 145 can select. The LLM 145 selects the reprompt flag in response to the output of the LLM 145 not meeting a threshold confidence level specified in the dispatch prompt. In some embodiments, the LLM 145 additionally generates a question for a user in response to selection of the reprompt flag. The question may request additional information needed by the LLM 145 to determine a response to the dispatch prompt. The LLM 145 may provide the question to the UI generation module 150, which displays the question to the user, thus prompting the user to input additional text or a new query. In some embodiments, the LLM 145 may select the reprompt flag by including a “reprompt” field in a JSON text output generated by the LLM 145. The output may also include text of the question to be presented to the user via a chat user interface.

Edges 240 are links between nodes. Each edge may link a first node and a second node and indicate where an output of the first node is to be used as input to the second node. Edges may be stored as computer-executable instructions at each node, where the computer-executable instructions indicate another node to send outputs to. In some embodiments, the edges are stored as output instructions at corresponding nodes. Alternatively, edges may be stored as separate data from the nodes of the agentic workflow (e.g., in a lookup table or a database) and may be referenced when the computer-executable instructions for a node have been completed. The agentic workflow module 135 executes an agentic workflow by executing the computer-executable instructions of the nodes of the agentic workflow. The agentic workflow module 135 may execute the agentic workflow in response to receiving natural-language text from the user device 100 (e.g., through a chatbot interface). The agentic workflow module 135 traverses the agentic workflow to access and execute computer-executable instructions for nodes in its traversal path – e.g., the nodes selected in the agentic workflow based on outputs determined from computer-executable instructions of previous node connected via edges to the selected nodes. For a current node in the agentic workflow, the agentic workflow module 135 may access computer-executable instructions of first node of the agentic workflow and compiles the instructions for execution. For example, if a node includes source code as part of its computer-executable instructions (e.g., main-action, input instructions, or output instructions), the agentic workflow module 135 may compile the source code into executable code. The agentic workflow module 135 selects a next node in the agentic workflow and executes the computer-executable instructions of the next node. The agentic workflow module 135 may repeat this process until it reaches a terminating node in the agentic workflow. A terminating node may be a node that includes instructions that terminate the execution of the agentic workflow or may be a node that has no edges other than the edge that leads to the node.

For instance, the agentic workflow module 135 may begin its traversal at a root node 250 of the agentic workflow, which is the first node in the agentic workflow. The agentic workflow module 135 accesses and executes the computer-executable instructions of the root node and determines a next node in the agentic workflow based on the output of the computer-executable instructions. For example, if the root node is a dispatch node, the agentic workflow module 135 accesses the computer-executable instructions of the dispatch node and generates a prompt for the LLM 145 using a prompt template of the computer-executable instructions. The agentic workflow module 135 inputs the prompt to the LLM 145 and receives an output from the LLM 145 that identifies a command category. The command category represents all or a portion of the user’s intent indicated in the natural-language text. The user’s intent may relate to an action the user wants the online system 130 to perform via the agentic workflow. For example, “change my flight” relates to the user’s intent to have the online system 130 change her flight.

The agentic workflow module 135 identifies the next node based on an edge of the root node associated with the identified command category. The agentic workflow module 135 iterates through this process of executing computer executable instructions and identifying subsequent nodes until it reaches a terminating node at the end of the agentic workflow that includes computer-executable instructions that cause the agentic workflow module 135 to send an output to the user device 100 or that otherwise does not have any edges.

In some embodiments, the agentic workflow module 135 may identify candidate nodes in the agentic workflow to execute in parallel with execution of a current node. The agentic workflow module 135 identifies descendant agentic nodes in the agentic workflow based on the current node. Descendant nodes are nodes that are subsequent to (e.g., dependent on) the current node and are later in the agentic workflow than the current node. In some embodiments, dependent agentic nodes may require a significant (e.g., over a threshold amount of) time to execute interfacing calls (e.g., API calls). In some embodiments, a descendant node may be executed before the agentic workflow module 135 has begun execution, finished execution, or begun re-execution of the current node.

For a current node, the agentic workflow module 135 determines a set of descendant agentic nodes as candidate nodes that are subsequent to the current node (e.g., later in the agentic workflow than the current node) and connected to the current node directly via an edge. For example, the agentic workflow module 135 may follow edges in the agentic workflow to identify agentic nodes that may be preprocessed. In some embodiments, the agentic workflow module 135 may select candidate nodes that are indirectly connected to the current node – e.g., nodes that are connected to one or more nodes that branch from the current node via an edge. In some embodiments, the agentic workflow module 135 may perform a check at non-dispatch prompt nodes that are subsequent to the current node. More particularly, the agentic workflow module 135 may assess the pre-processing instructions of each node to identify and follow the edges until reaching an agentic node.

The agentic workflow module 135 identifies, for each candidate node, whether one or more preconditions of the respective candidate node are met. The preconditions represent requirements that must be fulfilled for the computer-executable instructions of the candidate node to be run. Preconditions may include specific information that the agentic workflow module 135 needs to execute the computer-executable instructions of the candidate node. For example, candidate node may require both destination and date information such that the LLM 145 may extract flight information as part of execution of the computer-executable instructions of the candidate node.

A user may create an agentic workflow for an LLM-based application using user interfaces generated by the UI generation module 150. The UI generation module 150 generates user interfaces for presentation through a client application on a user device 100. For example, the UI generation module 150 may perform the actions described in related Application No. 18/826,583, filed on September 6, 2024, which is incorporated by reference in its entirety. The UI generation module 150 may receive interactions to add nodes into an agentic workflow and may generate a UI element for each node in the agentic workflow. The interactions may specify computer-executable instructions for a corresponding node. Each UI element stores the primary instructions for the corresponding node and displays the computer-executable instructions when the user views the UI element. For example, a UI element for a prompt node may include the prompt template for a prompt to be sent to the LLM 145. Each UI element may also store the input or output instructions for the corresponding node. The UI generation module also generates UI elements that represent connections (e.g., edges) between nodes. For example, the connection UI elements may indicate where the output of one node is the input of another node.

### Example Generation of Database Queries

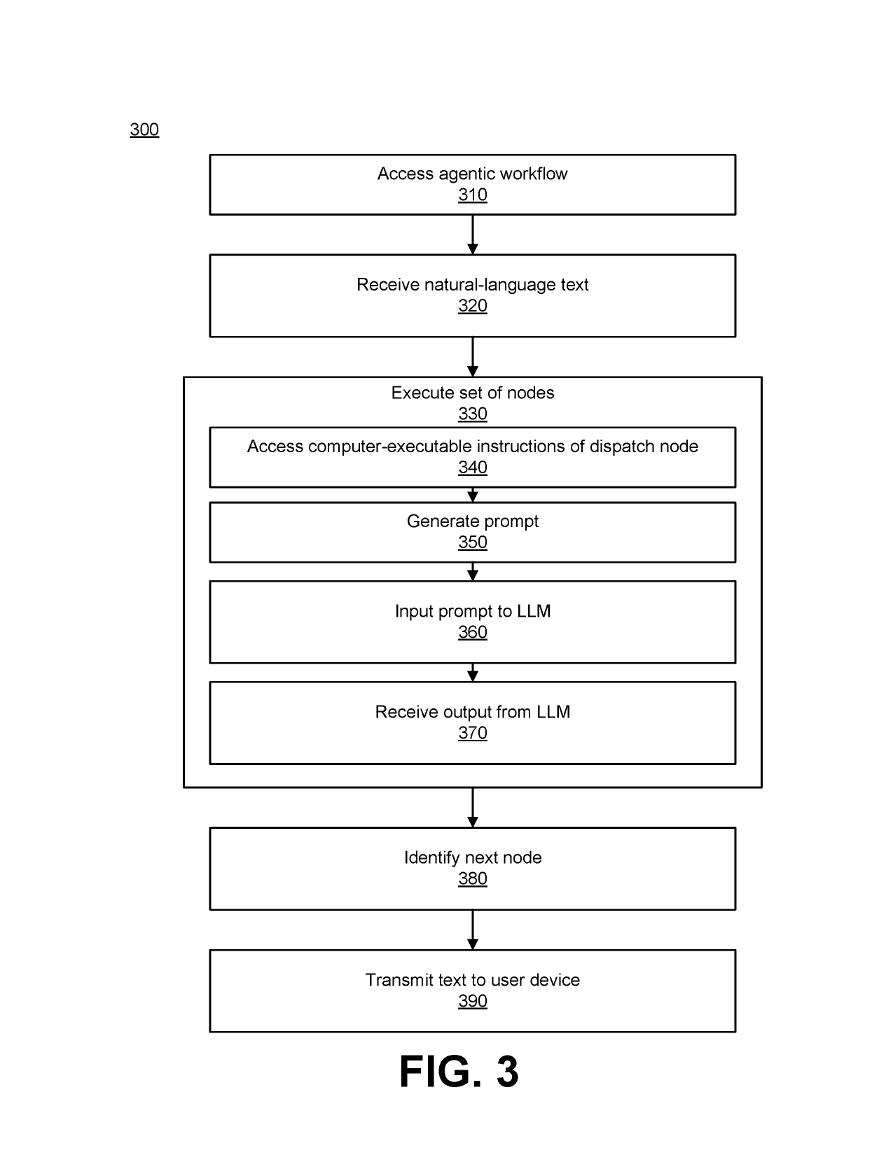

FIG. 3 is a flowchart of a method 300 for processing nodes of an agentic workflow, in accordance with one or more embodiments. In some embodiments, additional or alternative steps to those described in relation to FIG. 2 may be included in the method 300 and additional or alternative components may be used to execute the steps of method 300.

The online system accesses 310 an agentic workflow, where the agentic workflow comprises a set of nodes representing actions taken by the online system to execute the workflow. The set of nodes includes a plurality of prompt nodes and a plurality of agentic nodes. Each prompt node comprises computer-executable instructions for prompting a generative language model to generate an output for the agentic workflow, while each agentic node comprises computer-executable instructions for interfacing with a computing system. One or more of the prompt nodes may be a dispatch node that includes computer-executable instructions for prompting the generative language model to categorize an intent of a user interacting with the online system.

The agentic workflow may include a set of dispatch nodes and a set of agentic nodes. Each of the dispatch nodes includes a prompt template for generating a prompt for the generative language model. The prompt template for the dispatch nodes includes a list of command categories that the generative language model is instructed to select from. These command categories represent different descriptions of the intent of a user determined based on natural-language text received from a user device. For example, in the travel booking example, the command categories for a node may include “Flight,” “Hotel,” or “Taxi,” where these command categories refer to whether the user’s intent is to book a flight, hotel, or taxi, respectively. The prompt template includes a description of each command category (e.g., what kinds of user intents fall under each command category) and instructs the generative language model to determine, based on received natural-language text, which of the command categories best corresponds to the user’s intent. The prompt template may further include instructions for the generative language model to only identify a user’s intent and clarify that the generative language model should not generate a response to address the user’s intended action. During application of a dispatch node at a corresponding location in the agentic workflow, the online system 130 may create a prompt with the prompt template and apply generative language model to the prompt to determine a command category associated with the prompt. Each agentic node may be associated with an API call to a system, which may be a third-party system external to the online system 130 or a subsystem of the online system 130.

The agentic workflow may store edges between nodes that indicate that a command category of one node relates to the set of command categories at another node. When the generative language model selects one of the command categories in its response to a generated prompt, the online system identifies a next node in the agentic workflow using the edges between the nodes and executes the operations associated with the computer-executable instructions of the next node. If the next node is a dispatch node, the online system uses the prompt template at the next node to continue the iterative process. If the next node is an agentic node, the online system 130 executes the functionality associated with the computer-executable instructions of the agentic node.

The set of command categories in a dispatch node’s prompt template may relate to sub-categories of a command category in a parent dispatch node. For example, using the travel booking example, the root node of the agentic workflow may have “Flight,” “Hotel,” “Taxi,” and “Payment” as command categories. If the generative language model selects “Flight” as a command category for the user’s intent, the online system 130 uses the edges stored in the agentic workflow to identify the child node that corresponds to “Flight.” That child node may include a set of command categories that relate to “Flight,” such as “Book New Flight,” “Change Flight,” or “Change Seat.”

In some embodiments, the list of command categories includes an option for the online system to request that a human agent intervene in a chat session from which the natural-language text was received. The description of this command category may describe certain topics or sub-categories of user intents that should be referred to a human agent. For example, the prompt template may instruct that requests for refunds or service complaints should be handled by a human agent rather than by a chatbot. In some embodiments, the prompt template used for execution of a dispatch node includes fields for additional data to be included in the prompt. For example, the prompt template may include a field for including the text of the chat session with the user. In some embodiments, the online system may generate a summarized version of the chat session using the generative language model and may input that summarized version in the field for the chat session text. The prompt template may also include a field for user data describing the user to be included in the prompt.

The prompt template may also include a field for context data to be included in the prompt. The context data for a prompt is the data used by the generative language model to select a command category. For example, a dispatch node may include a prompt template for identifying a new flight for a user from a set of options. For this dispatch node, the context data may describe a set of flights for the generative language model to consider selecting from. In some embodiments, each dispatch node uses a unique set of context data for its prompt templates. For example, each dispatch node may use context data, or a combination of context data, that no other dispatch node in the agentic workflow uses.

When the online system 130 receives a request from a user to execute the user’s intent through a chat interface (e.g., via input of natural-language text), the online system 130 performs an iterative process through the agentic workflow to perform the action corresponding to the user’s intent. The online system 130 starts at a root node of the agentic workflow. The root node may be a dispatch node, and the online system 130 uses the prompt template of the dispatch node to generate a prompt to the generative language model. Generating the prompt may include collecting information (e.g., user data or context data) from databases within the online system 130 or third-party systems to input to the prompt template.

The online system 130 transmits the prompt (e.g., to identify a desired booking) to the generative language model and receives a response from the generative language model that identifies one command categories in the list of command categories included in the transmitted prompt. The online system 130 extracts the identified command category from the response, and the online system 130 uses the command category to identify a next node in the agentic workflow. For example, the agentic workflow may store a mapping for each dispatch node that indicates which node is the next node in the agentic workflow based on the solution descriptor selected by the generative language model.

If the next node in the agentic workflow is a dispatch node, the online system 130 repeats the process described above. Generally, each subsequent dispatch node relates to a narrower set of command categories and thereby narrows down to the user’s intent. At each of these steps in the iterative process, the online system 130 may request additional information from the user through the chat interface. The iterative process continues until the online system 130 reaches an agentic node of the agentic workflow. The online system 130 executes the action corresponding to the agentic node. For example, each agentic node may cause the online system 130 to perform some action within an internal subsystem of the online system 130 or may include an API call to a third-party system to perform some action (e.g., canceling a flight using an API call, adding amenities to a flight via an API call, etc.).

Returning to FIG. 3, the online system receives 320 natural-language text from a user device 100 associated with a user, where the natural-language text relates to an action to be performed by the online system 130 for the user. The online system executes 330 the set of nodes of the agentic workflow based on the received natural-language text.

Executing 330 the dispatch node includes accessing 340 the computer-executable instructions of the dispatch node, which include a prompt template for generating a prompt to the generative language model. The prompt template comprises text instructions for the generative language model to identify a command category from a set of command categories based on the natural-language text, where each command category is associated with an intended action of the user. The online system generates 350 a prompt for the generative language model based on the prompt template of the dispatch node and the received natural language text, and then inputs 360 the prompt to the generative language model.

The online system receives 370 an output from the generative language model, where the output comprises text data identifying a command category from the set of command categories. For the identified command category, the online system identifies 380 a next node for execution in the agentic workflow. The next node corresponds to the identified command category and is part of a sub-workflow of the agentic workflow for performing actions within the command category. The online system transmits 390 text to the user device 100, where the text describes an action performed by the online system based on execution of the set of nodes.

In some embodiments, the online system executes an agentic node of the plurality of nodes. For instance, the online system accesses the computer-executable instructions of the agentic node and executes an API call to the computing system. The computing system may be a third-party system or a subsystem of the online system 130. The online system receives information from the computing system related to the API call.

In some embodiments, the online system executes a prompt node of the plurality of nodes. The online system accesses the computer-executable instructions of the prompt node. The computer-executable instructions include a second prompt template for generating a second prompt to the generative language model. The online system generates a second prompt for the LLM based on the second prompt template of the prompt node and the received natural-language text. The online system inputs the second prompt to the generative language model and receives a second output from the generative language model. The output comprises text data identifying a second command category from the set of command categories. The online system identifies, for the second commend category, a second next node for execution in the agentic workflow.

In some embodiments, in parallel with execution of the dispatch node of the agentic workflow, the online system identifies a set of candidate agentic nodes in the agentic workflow by identifying a set of agentic nodes that descend from the current node within the agentic workflow. The online system identifies, for each candidate agentic node, whether one or more preconditions of the respective candidate agentic node are met. The one or more preconditions represent requirements for the respective candidate agentic node to be executed. In response to the one or more preconditions of the respective candidate node being met, the online system executes the respective candidate agentic node by executing the computer-executable instructions of the candidate agentic node.

### Example Prompt Testing User Interface

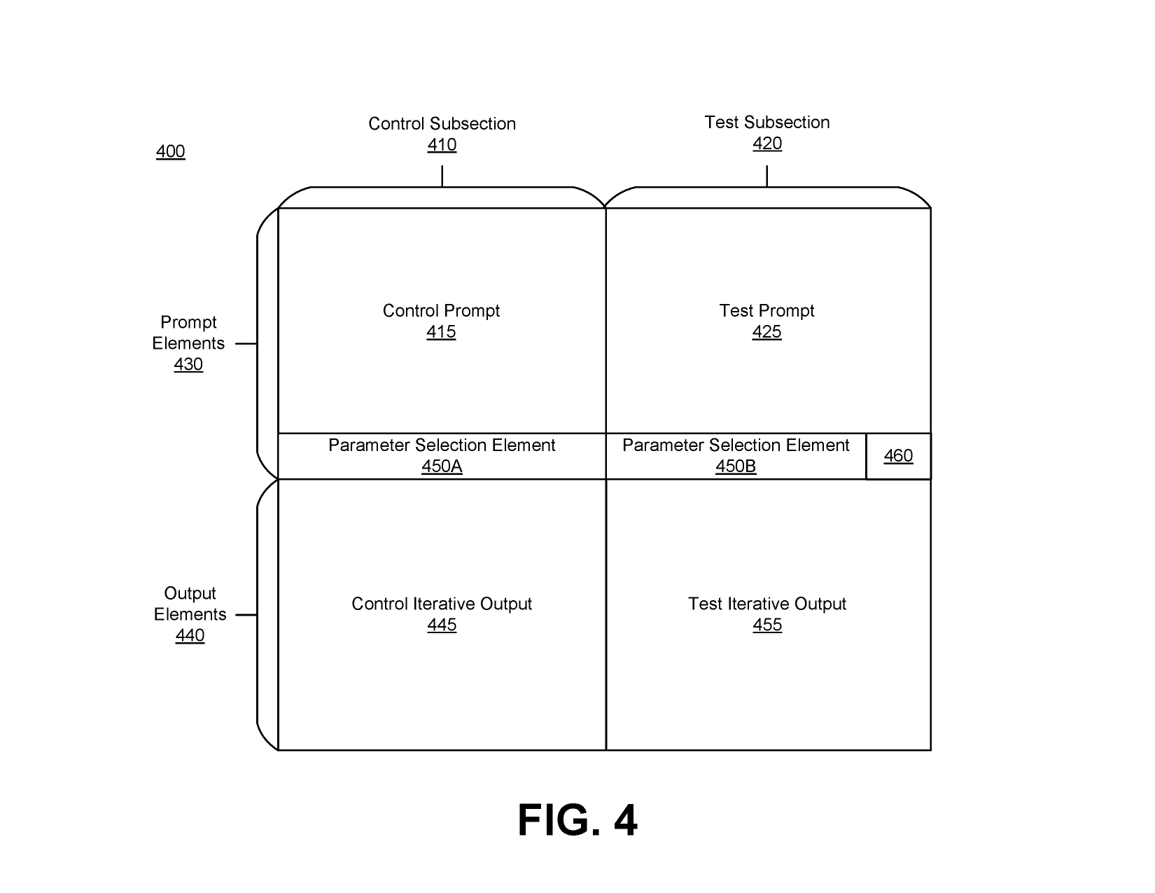

The online system may generate a user interface for testing prompts for the agentic workflow. In particular, the online system may generate a prompt testing user interface that enables the user to compare an original “control” prompt for a generative language model with a new “test” prompt and to compare the generated output for each over multiple iterations. FIG. 4 illustrates an example structure of a prompt testing user interface 400, in accordance with some embodiments. The prompt testing user interface 400 includes a control subsection 410 and a test subsection 420 that display information regarding the control prompt and the test prompt, respectively. Each subsection may include a prompt element and an output element. The prompt elements 430 are UI elements that a user may interact with to provide or edit text of a control prompt 415 or a test prompt 425, and the output elements 440 are UI elements that may display an output from a generative language model (such as LLM 145) based on the application of the generative language model to the respective prompts. In some embodiments, the prompt element 430 of each subsection includes parameter selection elements 450. These UI elements allow a user to select parameters to be used during application of the generative language model. For example, these parameters may specify which generative language model to use for the prompt or parameters for how a generative language model should generate its output (e.g., temperature or TopP values).

The prompt testing user interface 400 includes an iteration selection element 460 that allows the user to select how many iterations of the prompts to execute. Since generative language models commonly use some randomness in selecting their output, a user may want to execute multiple iterations of a test prompt to see how the test prompt performs overall. The online system 130 executes the control prompt 415 and the test prompt 425 the specified number of times to generate control iterative output 445 and test iterative output 455, respectively. These output elements 440 contain the responses from the generative language model that were generated in each of the iterations, and are displayed adjacent to each other to allow a user to compare the outputs.

In some embodiments, the control prompt or test prompt may include or be associated with language that indicates that the prompts are templates that include referred data. For example, a user may select or input referred data via interactive elements included at the prompt testing user interface, and the prompt testing user interface may automatically populate corresponding portions of the template(s) with the referred data.

In some embodiments, the prompt testing user interface 400 includes one or more elements that allow a user to select a chat history for use in the prompt(s). The chat history can be an artificial one that the user generated manually or may be part or all of a previous chat that a user had with the online system 130. The online system 130 uses the provided chat history to generate prompts with the control prompt template or test prompt template. The prompt elements 430 may be populated with the generated prompts, such that the user may view or later the prompts. The generated prompts may be input to selected generative language models, and output elements 440 may be updated to display the output in the control output element 604 or test output element 607, respectively.

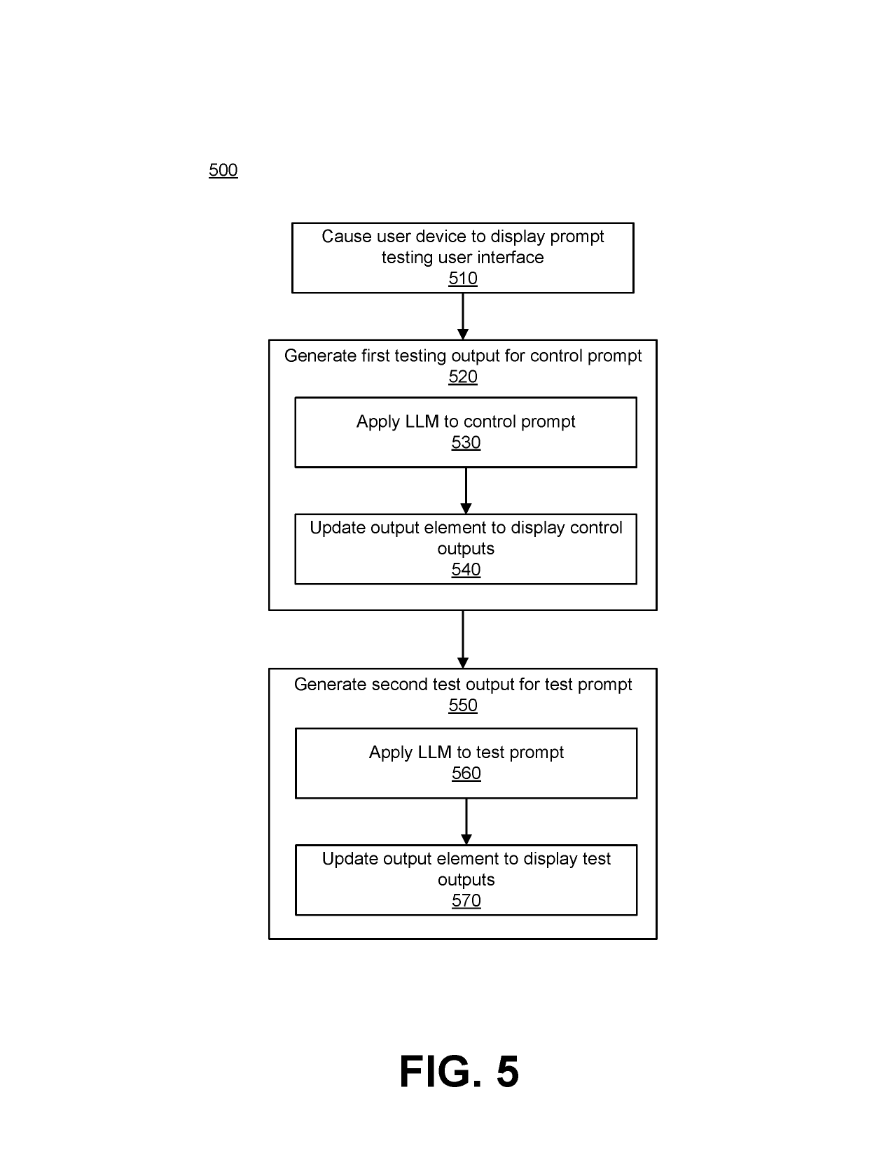

FIG. 5 is a flowchart of a method 500 presenting and updating a prompt testing user interface, in accordance with some embodiments. In some embodiments, additional or alternative steps to those described in relation to FIG. 5 may be included in the method 500 and additional or alternative components may be used to execute the steps of method 500.

The online system causes 510 a user device 100 to display a prompt testing user interface. The prompt testing user interface includes a control subsection and a test subsection, where each subsection comprises a prompt element and an output element. The prompt element is a user interface element that displays the text of a prompt used for the corresponding subsection, and the output element is a user interface element that displays output from a generative language model ( such as LLM 145) when the model is applied to the prompt of the corresponding subsection. The online system generates 520 a first testing output for a control prompt of the control subsection by applying 530 the generative language model to the control prompt a specified number of times to generate a plurality of control outputs. The online system updates 540 the output element of the control subsection in the prompt testing interface to display the plurality of control outputs. The online system also generates 550 a second testing output for a test prompt of the test subsection by applying 560 the generative language model to the test prompt the specified number of times to generate a plurality of test outputs. The online system updates 570 the output element of the test subsection in the prompt testing interface to display the plurality of test outputs.

In some embodiments, in response to receiving an interaction with the test prompt element to update the test prompt, the online system generates a new testing output for the new test prompt. In particular, the online system applies the generative language model to the new test prompt the specified number of times to generate a second plurality of test outputs, and the UI generation module 150 updates the test output element to display the second plurality of test outputs.

In some embodiments, each subsection includes one or more parameter elements, and each parameter element is configured to receive an interaction via the user device 100 that alters a respective parameter of a set of parameters. Each prompt may include parameters selected via the parameter elements of the respective subsection. The parameters may include a set of previous test outputs, a set of generative language models, a variation level of a selected generative language model, a size of a respective prompt, and a temperature of a respective prompt.

In some embodiments, the online system highlights differences between the test output and the control output. For example, the online system may compare text of the output element of the test subsection to text of the output element of the control subsection. The online system identifies one or more portions of the text of the output element of the test subsection that differ from the text of the output element of the control section. The online system causes the user interface to highlight the one or more portions of the text of the output element of the test subsection. In some embodiments, the online system highlights the one or more portions of the text of the output element of the test subsection by outlining a perimeter of each of the one or more portions.

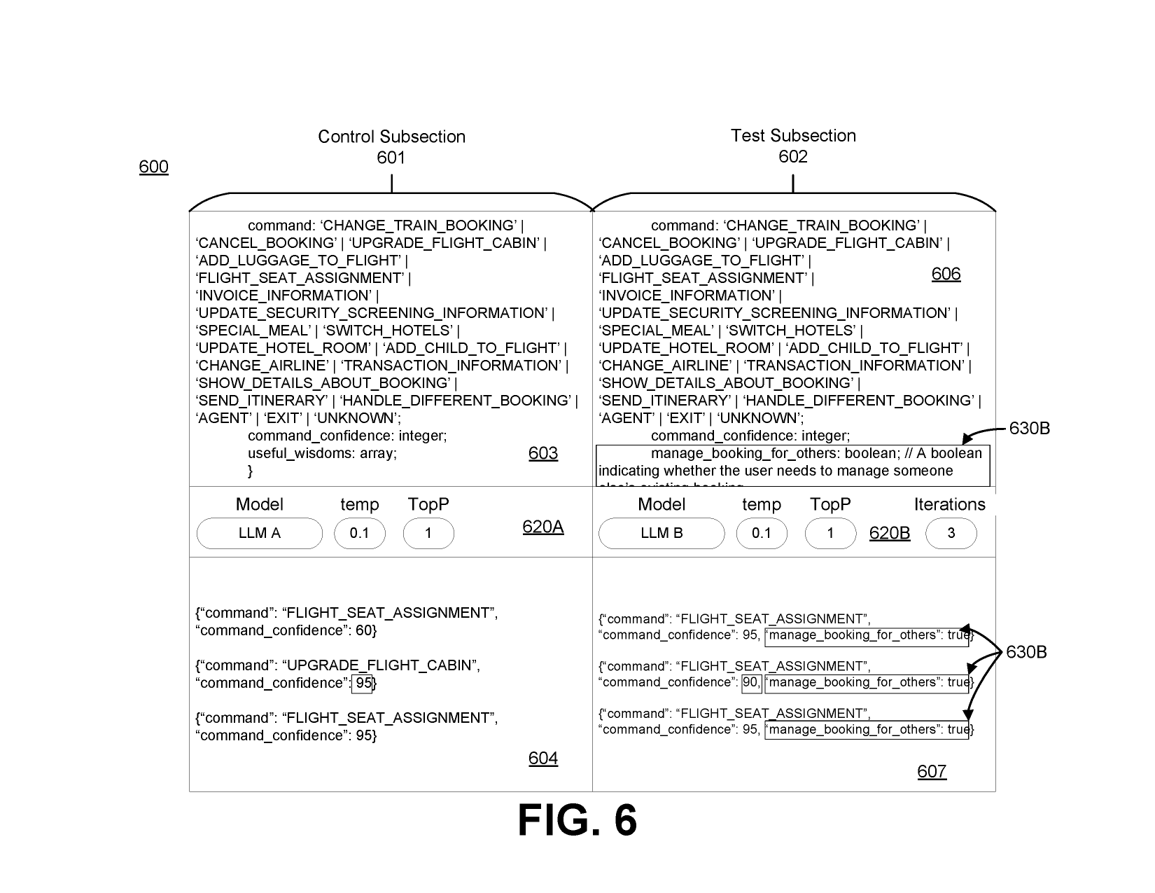

FIG. 6 illustrates an example prompt testing user interface 600, in accordance with one or more embodiments. The prompt testing user interface 600 includes a control subsection 601 and test subsection 602. The control subsection 601 displays the text for a control prompt template in the control prompt element 603. A user can interact with UI elements within the control prompt element 603 to alter fields in the control prompt template. A user may also interact with parameters 620A within the control prompt element 603 that allow the user to select which generative language model to use, a temperature for the generative language model’s response, and how many times the prompt should be tested. The test subsection 602 displays the text for a test prompt template in the test prompt element 606. A user can interact with UI elements within the test prompt element 606 to alter fields in the test prompt template. A user may also interact with parameters 620B within the test prompt element 606 that allow the user to select which generative language model to use, a temperature for the generative language model’s response, and how many times the prompt should be tested.

To test a prompt, the user may provide a chat history for use in the test. The chat history can be an artificial one that the user generated manually or may be part or all of a previous chat that a user had with the online system 130. The online system 130 uses the provided chat history to generate prompts. The online system 130 prompts the selected generative language model (such as LLM 145) using a prompt generated from the control prompt template or test prompt template and displays the output in the control output element 604 or test output element 607, respectively. Importantly, the online system 130 may repeatedly prompt the generative language model using the prompts to generate multiple responses. These outputs are listed in the control output element 604 and test output element 607. The user can compare outputs in the control output element 604 and the test output element 607 to glean how different prompts performed, how the generative language model performs with various prompts, and the like. The user can determine based on the comparison whether one prompt receives more consistent responses from the generative language model than the other.

For example, in some embodiments, the test output element includes several outputs provided by the generative language model in response to inputting the prompt of the prompt template to the generative language model (e.g., the “LLM A” or “LLM B” shown in FIG. 6). The outputs may include highlights 630B overlaid on text that differs from outputs in the control output element 604. The prompt template of the control prompt element 603 differs from the prompt template of the test prompt element 606 based on the addition of the text “manage_booking_for_others: boolean; // A boolean indicating whether the user needs to manage someone else’s existing booking.” By adding this in the prompt template of the test prompt element 606, the user is signifying that the booking being described by in the output is for another individual (e.g., their boss) and not the user themselves. Upon running the prompt from the updated prompt template (e.g., by inputting the prompt to the generative language model), the outputs in the test output element 607 are updated to correspond to new outputs from the generative language model. The user interface 600 also includes highlights overlaid on text that differs from the outputs of the control output element 604 and the outputs of the test output element 607The user may save the prompt of either prompt template such that the user may select it from among saved prompts in the parameters 620 during further prompting.

### Example Method for Executing Nodes in Parallel

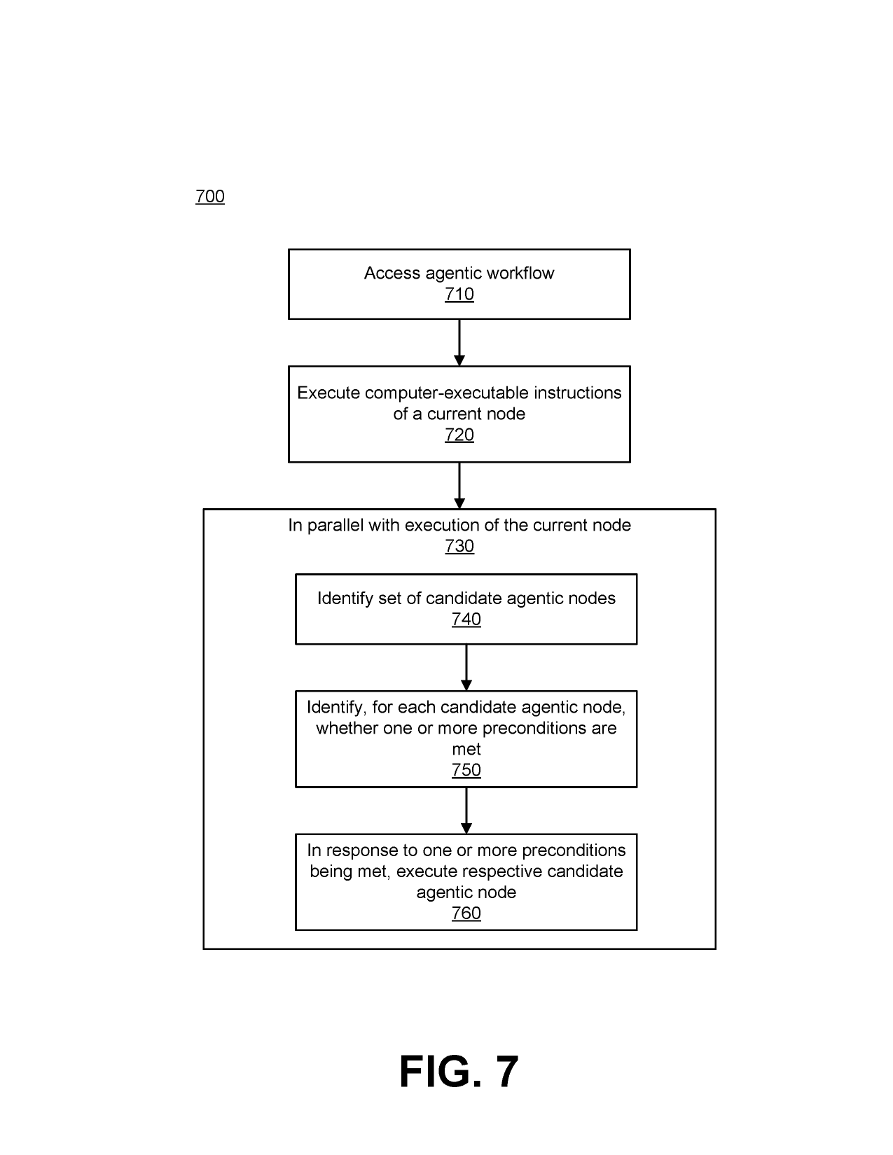

FIG. 7 is a flowchart of a method 700 for executing candidate nodes in parallel with execution of a current node, in accordance with one or more embodiments. In some embodiments, additional or alternative steps to those described in relation to FIG. 7 may be included in the method 700 and additional or alternative components may be used to execute the steps of method 700.

The online system accesses 710 an agentic workflow. The agentic workflow comprises a set of nodes that includes a plurality of prompt nodes and a plurality of agentic nodes. Each prompt node comprises computer-executable instructions for prompting a generative language model to generate an output for the agentic workflow, and each agentic node comprises computer-executable instructions for interfacing with the online system. The online system executes 720 the computer-executable instructions of a current node within the agentic workflow. Execution of a node of an agentic workflow is described in further detail above.

The online system identifies 740 a set of candidate agentic nodes in the agentic workflow to execute in parallel 730 with execution of a current node. Candidate agentic nodes are agentic nodes that descend from the current node, meaning that the agentic node is located later in the agentic workflow than the current node The online system may, starting from the current node, follow edges in the agentic workflow to identify agentic nodes that may be preprocessed as candidate agentic nodes. The online system may select agentic nodes that are directly or indirectly connected to the current node. An agentic node is directly connected to the current node when an edge connects the two and is indirectly connected to the current node when one or more other nodes are located between the agentic node and the current node. The online system may select all agentic nodes that descend from the current node as candidate agentic nodes or may select a subset of agentic nodes that descend from the current node that require over a threshold amount of time to execute interfacing calls.

For each candidate agentic node, the online system identifies 750 whether one or more preconditions associated with the respective candidate agentic node are met. In some embodiments, the online system assesses the preconditions during the identification of the candidate agentic nodes. The preconditions represent requirements for the respective candidate agentic node to be executed. Preconditions may include information that a respective candidate agentic node requires for execution. For example, a candidate node that accesses flight information may be associated with the precondition of a date on which to check for flight information. In response to the one or more preconditions of a respective candidate agentic node being met, the online system executes 760 that candidate agentic node in parallel with the current node by executing its computer-executable instructions. In some embodiments, the online system may execute the candidate agent node before, during, or after execution of the current node. In response to a precondition for a candidate agentic node not being met, the online system may remove that agentic node as a candidate. In some embodiments, the online system also removes any other candidate agentic nodes that descend from the respective agentic node.

In some embodiments, the online system may finish executing the instructions associated with a candidate agentic node before processing of the current node has finished. The online system may use the output of the candidate agentic node to execute candidate agentic nodes that descend from the respective candidate agentic node. In some embodiments, the online system selects a branch of the agentic workflow as being the most likely branch of nodes to be executed, which the online system may select by applying generative language model. The online system may apply the generative language model to the output of the respective candidate agentic node and, in some embodiments, an input to the current node or a description of the processing being performed at the current node. The online system may receive likelihoods for each branch of nodes that descend from the respective candidate agentic node and select each branch with a likelihood over a threshold or select a branch with the highest likelihood. The online system may execute a next node in the selected branch(es).

To execute nodes in parallel, the online system may begin execution of computer-executable instructions at the current node. While those instructions are executing, the online system may determine one or more candidate agentic nodes to process in parallel and begin executing the computer-executable instructions of those nodes while the computer-executable instructions of the current node are still being executed. The online system may execute an API call to an external system (such as an entity system 110) for each set of computer-executable instructions being executed for a candidate agentic node. The online system receives information from an external system related to each API call. The online system may store this information such that the information may be quickly accessed once execution of the computer-executable instructions of the current node has finished. For example, the execution associated with the current node may result in an output indicative of a next node in the agentic workflow, which the online system may have already obtained information for via the pre-processing.

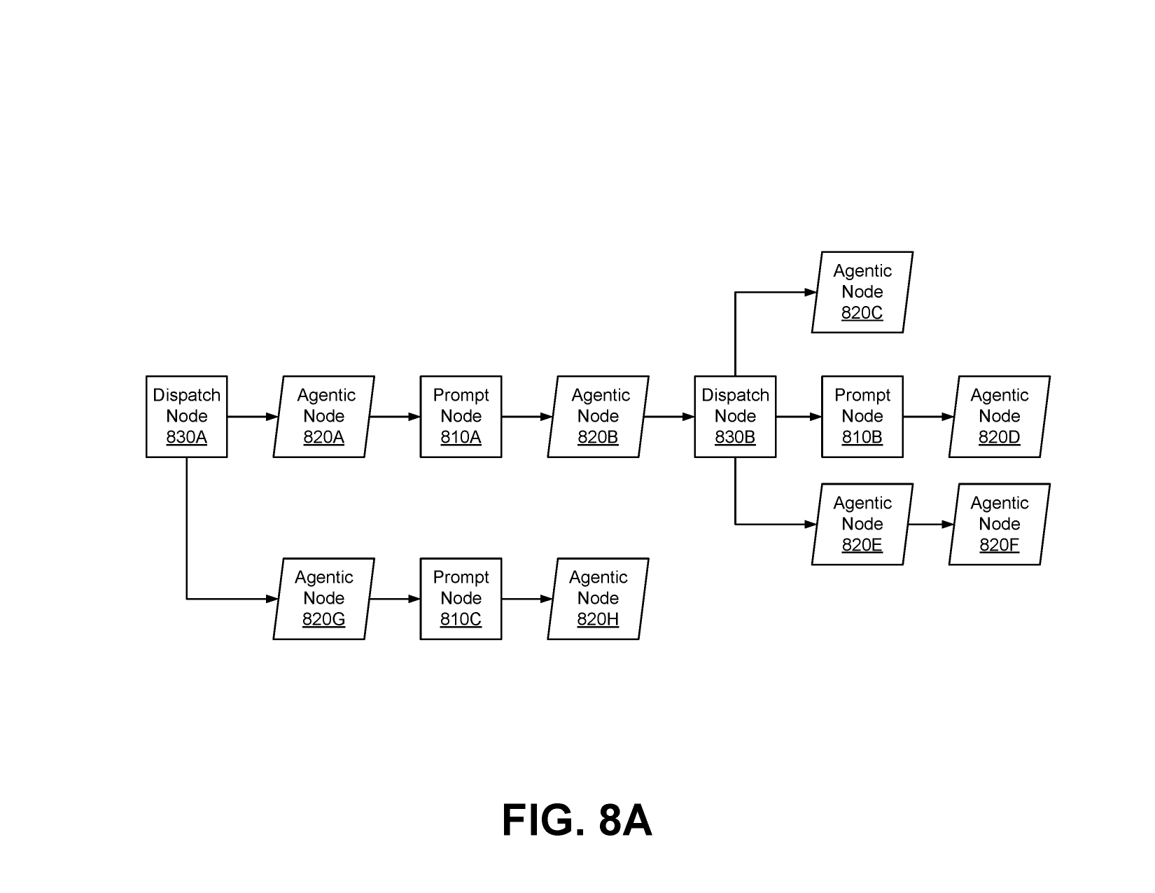

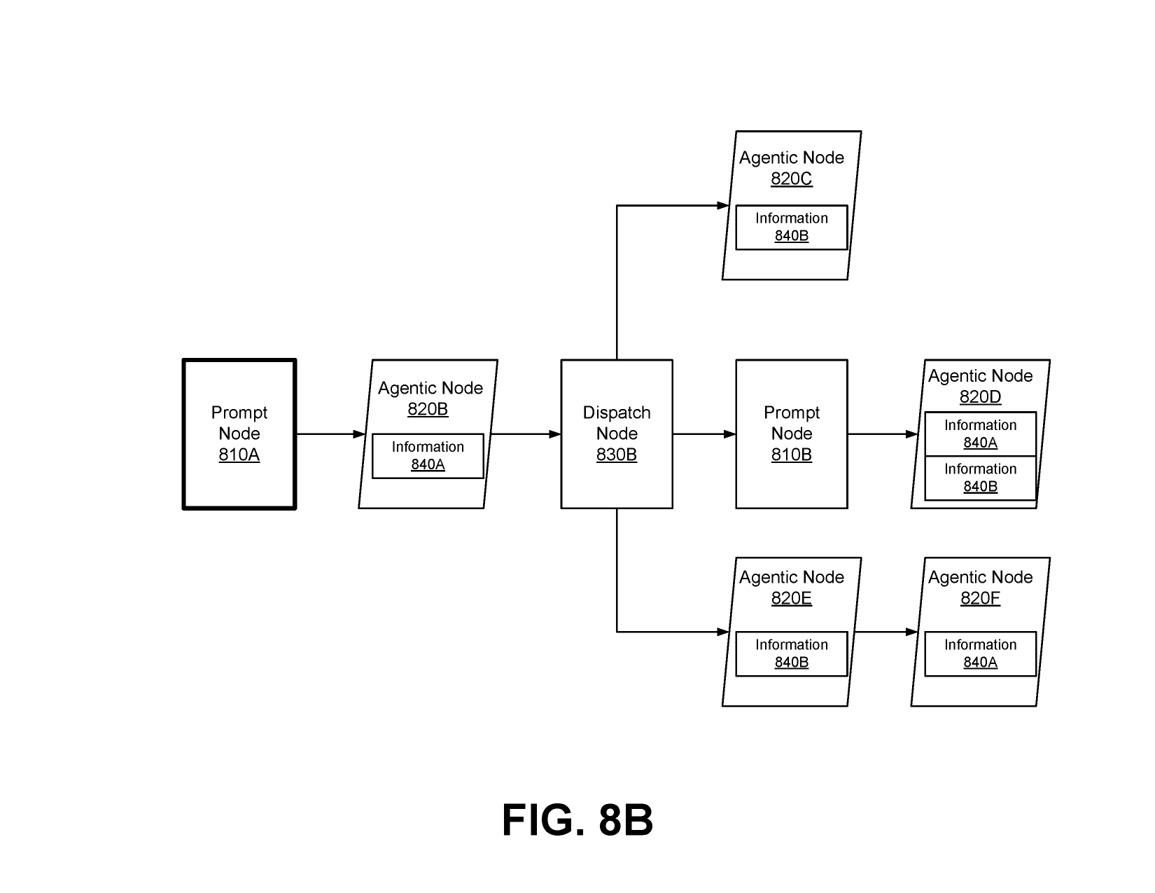

FIG. 8A illustrates an agentic workflow including agentic nodes that may be considered candidate agentic nodes, in accordance with some embodiments. For a current node, the online system determines a set of candidate agentic node that descend from the current node in the agentic workflow. For example, if dispatch node 830A is the current node, the online system may select all of agentic nodes 820A-H as candidate agentic nodes. In another example, if prompt node 810A is the current node, the online system may only select agentic nodes 820B-F as candidate agentic nodes as those agentic nodes depend on prompt node 810A in the agentic workflow and agentic nodes 820A and 820G-H do not.

The online system identifies one or more candidate agentic nodes 820 that may be processed in parallel with the current node. As shown in FIG. 8B, which depicts a portion of the agentic workflow, each agentic node 820 is associated with information 840 that the node needs for processing. Each agentic node 820 may require, as a pre-condition, that the information 840 it needs for processing be available at a current node for the online system to process the respective agentic node 820 in parallel with the current node. For example, the online system may select agentic nodes 820A-F as candidate nodes when prompt node 810B is the current node. At prompt node 810A, the online system may have information 840A (e.g., this information may have been generated or retrieved by the online system). Agentic node 820B is associated with a pre-condition of requiring information 840A. Since the online system has information 840A, the online system may identify agentic node 820B and process agentic node 820B in parallel with prompt node 810A. However, agentic node 820C requires information 840B to execute, but the online system does not have information 840B (e.g., this information may be generated or retrieved at agentic node 840B). Agentic nodes 820C and 820E both have pre-conditions that require information 840B, so the online system does not select those nodes for parallel processing.

Though one pre-condition for agentic node 820D is met (e.g., the online system has information 840A), not all pre-conditions for agentic node 820D are met (e.g., the online system does not have information 840B), so agentic node 820D is also not selected for parallel processing. Though agentic node 820F depends on agentic node 820E, which the online system determined cannot be parallel processed, the online system may identify agentic node 820F for parallel processing with the current node as each of its pre-condition (e.g., the online system having information 840A) have been met. However, if agentic node 820F required an output from agentic node 820E for processing, the online system would not identify agentic node 820F for parallel processing.

### Example Application of Supervisor Routine

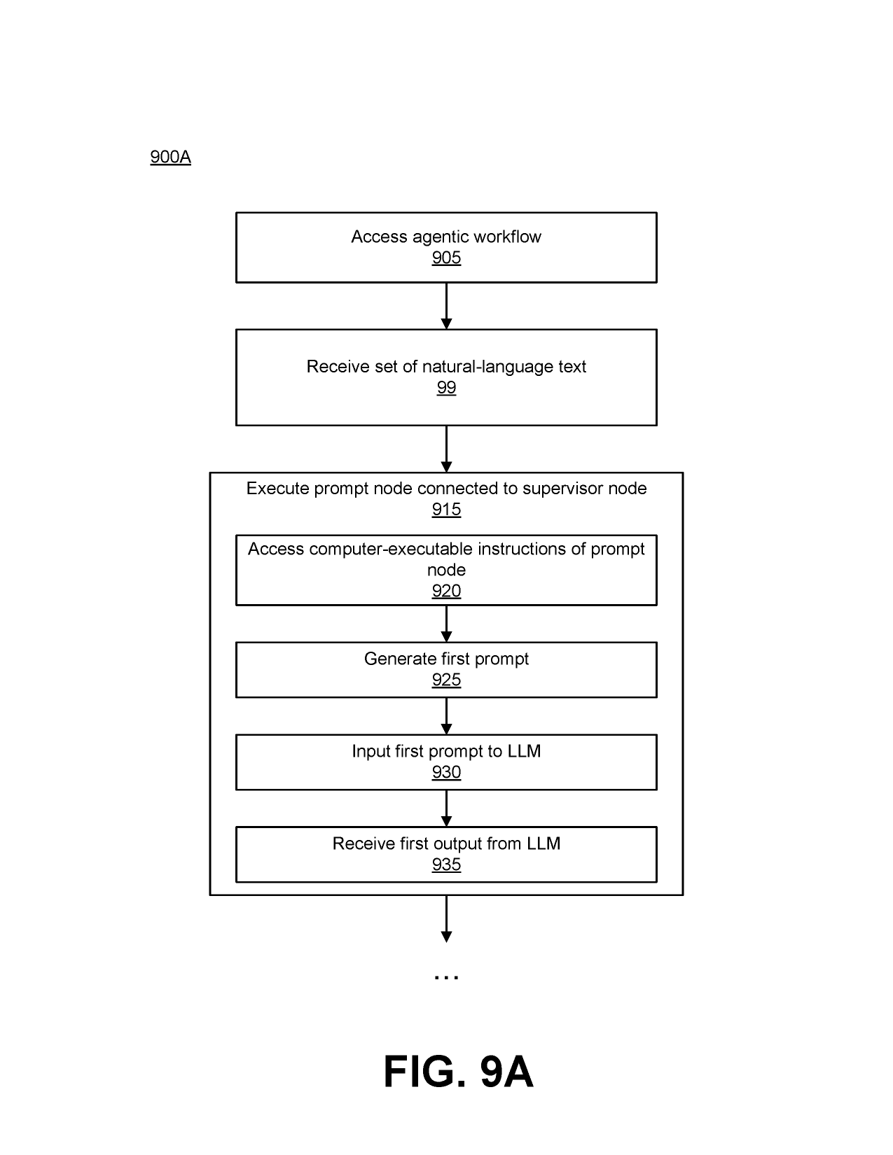

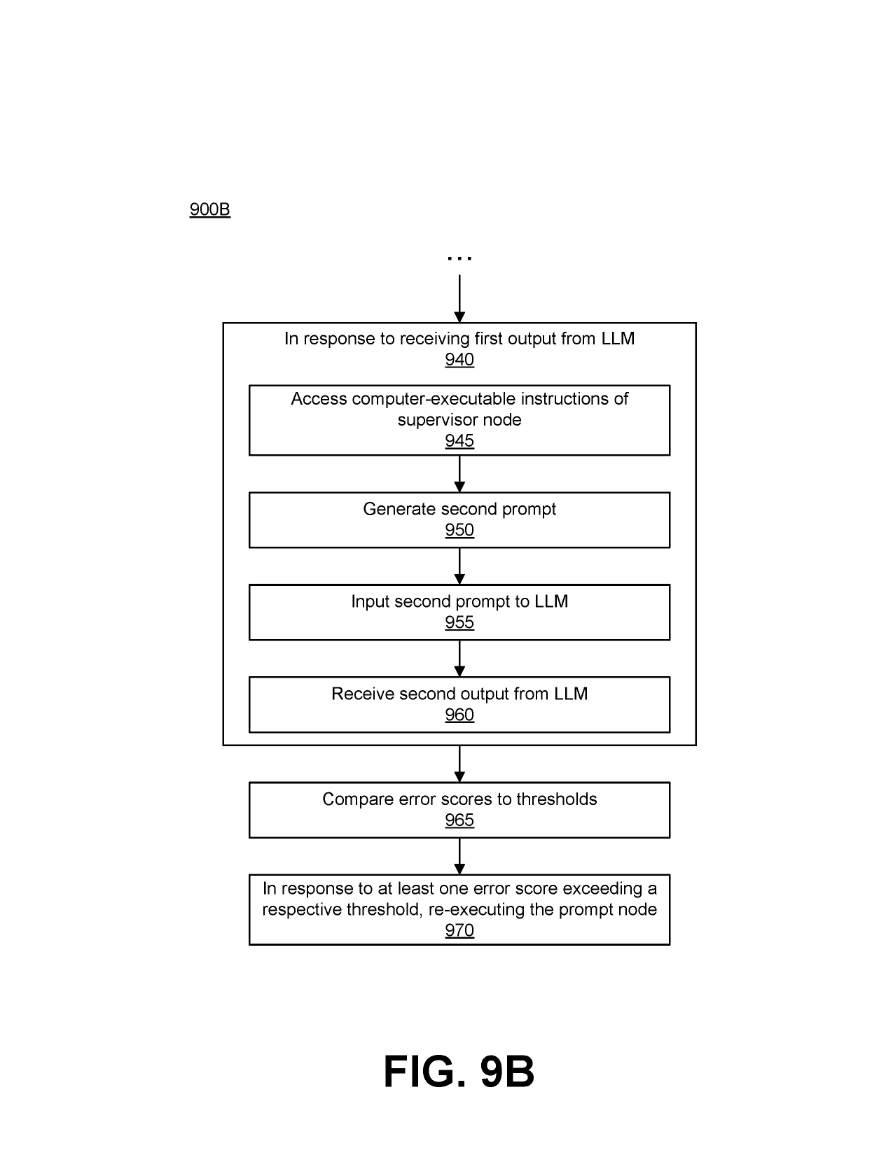

FIGS. 9A-B illustrate a flowchart of a method 900 for applying a supervisor routine to an output of a generative language model, in accordance with one or more embodiments. In some embodiments, additional or alternative steps to those described in relation to FIGS. 9A-B may be included in the method 900 and additional or alternative components may be used to execute the steps of method 900.

An online system (such as online system 130) accesses 905 an agentic workflow, where the agentic workflow comprises a set of nodes that includes a plurality of prompt nodes and a plurality of agentic nodes. The plurality of prompt nodes may be connected to a supervisor node in the agentic workflow. In some embodiments, each prompt node in the agentic work is connected to the same supervisor node in the agentic workflow. Each supervisor node is a final node in a chain of nodes that start at a root node of the agentic workflow. Put another way, each supervisor node is a final node in a branch of the agentic workflow, such that the online system will execute a supervisor node upon reaching an end of the agentic workflow, regardless of where the end is within the agentic workflow. Each supervisor node includes computer-executable instructions for prompting the generative language model to apply guidelines to an output of a connected prompt node. Put another way, the supervisor node includes instructions for verifying the output of its parent node (e.g., the node that the supervisor node descends from) in the agentic workflow. In some embodiments, the supervisor node may include computer-executable instructions for prompting the generative language model to detect types of errors in outputs of prompt nodes. For example, the supervisor node may include a prompt for checking whether an output includes non-existent flight information (e.g., hallucinated flight information).

The online system receives 910 a first set of natural-language text from a client device associated with a user, where the first set of natural-language text relates to an action to be performed by the online system for the user. The online system executes 915 a prompt node from the set of nodes that is connected to a supervisor node through an edge in the agentic workflow. Executing 915 the prompt node includes accessing 920 its computer-executable instructions, which include a first prompt template for generating a first prompt to the generative language model. The online system generates 925 the first prompt for the generative language model based on the first prompt template and the first set of natural-language text, inputs 930 the first prompt to the generative language model, and receives 935 a first output from the LLM.

In response to receiving the first output from the generative language model, the online system executes 940 the supervisor node, e.g., by accessing 945 the computer-executable instructions of the supervisor node, which include a second prompt template. The second prompt template contains instructions for the generative language model to generate a set of error scores. Each error score represents a likelihood that the first output includes a particular type of error. Each type of error is a category of mistake in the first output, and types of errors include facts in the first output that are false, an indication in the first output for the online system to perform an action that it is unable to perform, and language included in the first output that should not be included (e.g., profanity). More specific examples of types of errors include the first output providing less than an hour for a layover, not including a buffer time between a flight’s landing and a scheduled meeting, not selecting a user’s preferred seat within a plane (e.g., aisle, middle, window), not scheduling ride on a hotel’s airport shuttle for a user, etc.

The online system generates 950 a second prompt for the generative language model based on the second prompt template and the first output. The second prompt includes text instructions for how to evaluate the first output to determine whether one or more error types are included in the first output. The online system inputs 955 the second prompt to the generative language model and receives 960 a second output, which includes a set of error scores identified for the first output. The online system compares 965 each error score to a threshold and determines that types of errors associated with respective error scores above the threshold are present in the first output. In some embodiments, each type of error is associated with its own threshold that the online system compares scores to. In response to at least one error score exceeding the threshold, the online system re-executes 970 the prompt node.

To re-execute the prompt node, the online system may re-access the computer-executable instructions of the prompt node. The online system generates a third prompt using the first prompt template of the prompt node. The third prompt includes the first set of natural-language text and the error types identified in the first output. The online system inputs the third prompt to the generative language model and receives a third output from the generative language model, which is a replacement for the first output. In response to receiving the third output from the generative language model, the online system generates a fourth prompt based on the second prompt template and the third output. The online system re-executes the supervisor node using fourth prompt, which causes the generative language model to output a second set of error scores. The online system may compare each error score of the second set to the threshold. In response to the at least error one score of the second set being outside of its respective threshold, the online system may send the third output to a user device of an external operator, such that the external operator may edit the third output to remove any errors. In some embodiments, the online system also sends identifiers of each error type to the external operator for review with the third output.

In response to all error scores being below the threshold, the online system may send the third output for presentation at a user device. The online system may cause the user device to present a chat interface that includes the first output as a response to the first set of natural-language text. In some embodiments, the online system trains the generative language model on chat data from the chat interface. The chat data may include outputs previously presented at the chat interface in response to sets of natural-language text. Each output may be associated with a presentation score and labeled with at least a portion of a chat between a user and the online system, such as a set of natural-language text preceding the respective output. In some embodiments, the presentation score is rating of the output indicated by a user via the chat interface. In some embodiments, each output is further labeled with one or more actions taken by the user within a threshold amount of time of presentation of the output, such as interacting with a UI element presented with the output or entering a new set of natural-language text.

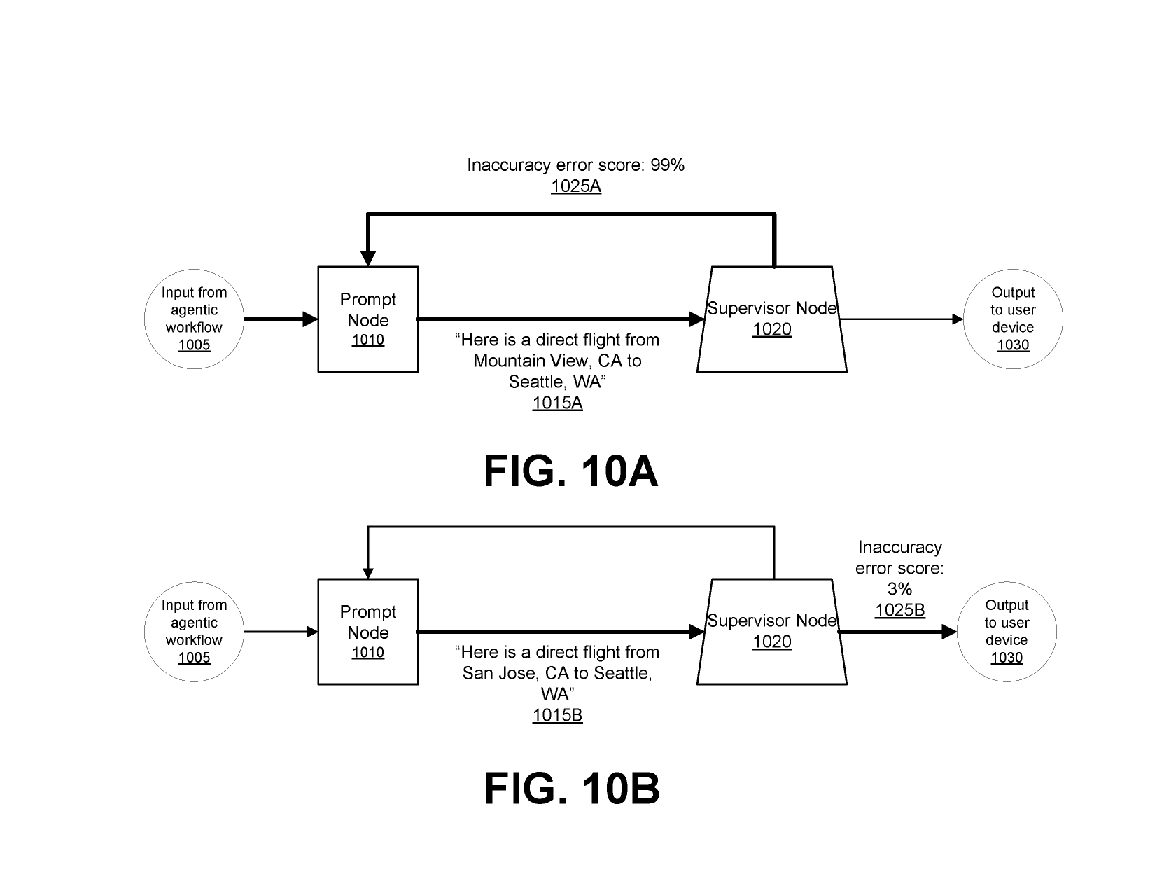

FIGS. 10A-B illustrate example applications of a supervisor routine, in accordance with some embodiments. In FIG. 10A, a prompt node 810 receives an input 1005 from an agentic workflow, which may include more nodes not pictured in FIG. 10A. The prompt node generates the response 1015A “Here is a direct flight from Mountain View, CA to Seattle, WA,” which is provided to a supervisor node 1020. The supervisor node 1020 evaluates the response 1015A and determines an inaccuracy error score 1025A of 98%. Though described in relation to inaccuracies in FIGS. 10A-B, in some embodiments, additional or alternative error scores may be generated by the supervisor node 1020. The inaccuracy error score 1025A is greater than an error threshold (e.g., 30%), so the supervisor node 1020 directs flow of the agentic workflow back to the prompt node 1010, such that the prompt node 1010 may generate a new response. The supervisor node 1020 may provide the prompt node 1010 with the inaccuracy error score 1025A and, in some embodiments, a textual explanation of the inaccuracy error score 1025A generated by the supervisor node 1020 (e.g., “Mountain View, CA does not have an airport and therefore cannot have direct flights to Seattle”).

In FIG. 10B, the prompt node 1010 produces the new response 1015B “Here is a direct flight from San Jose, CA to Seattle, WA.” The new response 1015B is provided to the supervisor node 1020, which determines a new inaccuracy error score 1025B of 3%. The new inaccuracy error score is below the threshold, so the supervisor node 1020 provides the new response 1015B for output 1030 to a user device. In some embodiments, the supervisor node 1020 may maintain a count of instances of determining error scores for a response within a threshold amount of time or since a response was last output to a user device. If the supervisor node 1020 determines that the count has exceeded a repetition threshold (e.g., the prompt node 1010 has failed to provide a response 1015 with error scores sufficient for output 1030 to the user device), the supervisor node 1020 may provide a most recently generated response 1015 to a user device of an external operator, such that the external operator may edit the most recent response to fix any errors. In some embodiments, the supervisor node 1020 provides all of the responses and associated error scores to the user device of the external operator.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method for presenting a graphical user interface configured to test large language model prompts, the method comprising:
causing a client device to display a prompt testing user interface, the prompt testing user interface including a control subsection and a test subsection, wherein each subsection comprises a prompt element and an output element, wherein the prompt element is a user interface element for displaying text of a prompt used for a corresponding subsection, and the output element is a user interface element for displaying output from a large language model when the large language model is applied to the prompt of the corresponding subsection;
generating a first testing output for a control prompt of the control subsection by:
applying the large language model to the control prompt a specified number of times to generate a plurality of control outputs; and
updating the output element of control subsection of the prompt testing interface to display the plurality of control outputs; and
generating a second testing output for a test prompt of the test subsection by:
applying the large language model to the test prompt the specified number of times to generate a plurality of test outputs; and
updating the output element of the test subsection of the prompt testing interface to display the plurality of test outputs.

2. The method of claim 1, further comprising:
in response to receiving a first interaction with the prompt element of the test subsection, generating a third testing output for a second test prompt of the test subsection by:
applying the large language model to the second test prompt the specified number of times to generate a second plurality of test outputs; and
updating the output element of the test subsection of the prompt testing interface to display the second plurality of test outputs.

3. The method of claim 1, wherein each subsection further comprises one or more parameter elements, wherein each parameter element is configured to receive an interaction via the client device that alters a respective parameter of a set of parameters.

4. The method of claim 3, wherein parameters in the set of parameters include a set of previous test outputs, a set of large language models, a variation level of a selected large language model, a size of a respective prompt, and a temperature of a respective prompt, wherein the set of large language models includes the large language model.

5. The method of claim 3, wherein each prompt includes parameters selected via the parameter elements of the respective subsection.

6. The method of claim 1, further comprising:
comparing test of the output element of the test subsection to text of the output element of the control subsection;
determining one or more portions of the text of the output element of the test subsection that differ from the text of the output element of the control subsection;
causing the user interface to highlight the one or more portions of the text of the output element of the test subsection.

7. The method of claim 6, wherein causing the user interface to highlight the one or more portions of the text of the output element of the test subsection comprises outlining a perimeter of each of the one or more portions.

8. The method of claim 1, further comprising:
in response to generating a third testing output for the test prompt of the test subsection, updating the output element of the control subsection of the prompt testing interface to display the plurality of test outputs.

9. A non-transitory computer-readable medium storing computer-executable instructions that, when executed, cause a computing system to perform operations comprising:
causing a client device to display a prompt testing user interface, the prompt testing user interface including a control subsection and a test subsection, wherein each subsection comprises a prompt element and an output element, wherein the prompt element is a user interface element for displaying text of a prompt used for a corresponding subsection, and the output element is a user interface element for displaying output from a large language model when the large language model is applied to the prompt of the corresponding subsection;
generating a first testing output for a control prompt of the control subsection by:
applying the large language model to the control prompt a specified number of times to generate a plurality of control outputs; and
updating the output element of control subsection of the prompt testing interface to display the plurality of control outputs; and
generating a second testing output for a test prompt of the test subsection by:
applying the large language model to the test prompt the specified number of times to generate a plurality of test outputs; and
updating the output element of the test subsection of the prompt testing interface to display the plurality of test outputs.

10. The computer-readable medium of claim 9, further comprising:
in response to receiving a first interaction with the prompt element of the test subsection, generating a third testing output for a second test prompt of the test subsection by:
applying the large language model to the second test prompt the specified number of times to generate a second plurality of test outputs; and
updating the output element of the test subsection of the prompt testing interface to display the second plurality of test outputs.

11. The computer-readable medium of claim 9, wherein each subsection further comprises one or more parameter elements, wherein each parameter element is configured to receive an interaction via the client device that alters a respective parameter of a set of parameters.

12. The computer-readable medium of claim 11, wherein parameters in the set of parameters include a set of previous test outputs, a set of large language models, a variation level of a selected large language model, a size of a respective prompt, and a temperature of a respective prompt, wherein the set of large language models includes the large language model.

13. The computer-readable medium of claim 11, wherein each prompt includes parameters selected via the parameter elements of the respective subsection.

14. The computer-readable medium of claim 9, further comprising:
comparing test of the output element of the test subsection to text of the output element of the control subsection;
determining one or more portions of the text of the output element of the test subsection that differ from the text of the output element of the control subsection;
causing the user interface to highlight the one or more portions of the text of the output element of the test subsection.

15. The computer-readable medium of claim 14, wherein causing the user interface to highlight the one or more portions of the text of the output element of the test subsection comprises outlining a perimeter of each of the one or more portions.

16. The computer-readable medium of claim 9, further comprising:
in response to generating a third testing output for the test prompt of the test subsection, updating the output element of the control subsection of the prompt testing interface to display the plurality of test outputs.
